(19) United States
(12) Patent Application Publication
(10) Pub. No.: US 2013/0068700 A1
(43) Pub. Date: Mar. 21, 2013

(54) System and Method for Treatment of Liquids by Cavitation with Pressure Recovery Capability

(71) Applicant: Impulse Devices Inc., Grass Valley, CA (US)

(72) Inventor: Naresh Mahamuni, Nevada City, CA (US)

(73) Assignee: IMPULSE DEVICES INC., Grass Valley, CA (US)

(21) Appl. No.: 13/621,477

(22) Filed: Sep. 17, 2012

Related U.S. Application Data
(60) Provisional application No. 61/535,496, filed on Sep. 16, 2011.

(51) Int. Cl. C02F 1/36; B06B 3/00

(52) U.S. Cl. CPC C02F 1/36; B06B 3/00
USPC 210/748.03; 422/127

(57) ABSTRACT

An apparatus and method for treating a liquid by acoustic cavitation. In a first stage, in a cavitation chamber under positive static pressure. In a second stage by hydrodynamic cavitation. The energy and pressure expended in the first stage is recovered in the second stage to make an efficient processing system for cavitating liquids. The process and system may be used for disinfecting water.

### RELATED APPLICATIONS

The present applications claims the benefit and priority of U.S. Provisional Application 61/535,496, bearing the present title, filed on Sep. 16, 2011, which is hereby incorporated by reference.

### TECHNICAL FIELD

The present disclosure relates to processing liquids such as water using acoustic cavitation. More specifically, it relates to removing or destroying bacteria or other unwanted microbes and organisms present in said liquid. In addition, the disclosure is directed to systems and methods for pressure recovery in said liquids during such processes. Pressure recovery may be achieved by multi-stage cavitation processing in a flowing medium environment.

### BACKGROUND

It is desirable to remove harmful or unhealthful agents from water, especially water used in cooking, drinking, or bathing (sometimes referred to as “potable water”), which is or likely to be ingested by people and cause them to become ill. To eliminate harmful micro-organisms from potable water supplies of cities and towns, the water supplies are treated by some treatment method in a treatment facility. Smaller scale treatment systems are installed at individual properties if a communal water supply is not in use, e.g., to treat well water.

The most common water treatment methods are: filtration, distillation, reverse osmosis, adding chemical agents, and heat treatment. Each of this eliminates or kills or neutralizes the danger of certain types of harmful micro-organisms or microbes. The microbes of interest may include bacteria, algae, fungi or others.

Acoustic cavitation is known as an agent for affecting substances undergoing the cavitation process. Both hydrostatic and hydrodynamic cavitation methods are known to those skilled in the art. In hydrostatic cavitation, a fluid (usually at atmospheric pressure) is subjected to an ultrasonic field of sufficient intensity to cause localized cavitation events therein. Hydrostatic cavitation may be performed under a static pressure as described in patents and patent applications filed by and assigned to the present assignee, Impulse Devices, Inc., Grass Valley, Calif., USA. In hydrodynamic cavitation, a fluid is passed through an apparatus to cause localized pressure fluctuations that also induce cavitation in the fluid.

Hydrodynamic cavitation systems include rotating machinery and orifices and other components such as pumps or turbines or hydrofoils. This energy would typically be wasted or unrecovered after the fluid is released from its high pressure state to a lower pressure state. Energy is expended in some acoustic cavitation systems to pump a liquid up to an elevated static pressure state.

### SUMMARY

This disclosure is directed to placing hydrostatic pressure cavitation apparatus in series with a hydrodynamic cavitation apparatus so as to recover positive pressure input into said system before discharge in a flow-through processing cycle. The method can be applied in a multi-stage process including at least two cavitation stages in series. In some embodiments the first cavitation stage comprises acoustic cavitation of a liquid medium under hydrostatic pressure conditions and the second cavitation stage comprises hydrodynamic acoustic cavitation, e.g., using a venturi or similar flow-through device.

An aspect of the present method is directed to a multi-stage process for cavitating a liquid medium, comprising introducing a liquid medium into an acoustic cavitation device; pressurizing said liquid medium within the acoustic cavitation device to a desired pressure greater than ambient atmospheric pressure; applying acoustic cavitation to said liquid medium under pressure inside said acoustic cavitation device; releasing said liquid medium, after cavitating it in the acoustic cavitation device, to a hydrodynamic cavitation device; applying hydrodynamic cavitation to said liquid medium in the hydrodynamic cavitation device; and releasing the liquid medium from said hydrodynamic cavitation device.

Another aspect of the present system is directed to an apparatus treating a liquid using acoustic cavitation, comprising an acoustic cavitation device; a pressure source in fluid communication with said acoustic cavitation chamber; a hydrodynamic cavitation device in fluid communication with said acoustic cavitation device; said pressure source coupled to said acoustic cavitation device so as to raise a pressure of said liquid in said acoustic cavitation device above an ambient pressure; and said hydrodynamic cavitation device coupled to said acoustic cavitation device so as to receive a discharge of liquid from said acoustic cavitation device.

### BRIEF DESCRIPTION OF THE DRAWINGS

The present invention may be better described using the following drawings, which are provided for the sake of illustration and not by way of limitation or exhaustive recitation of the possible claimed embodiments.

FIG. 1 illustrates a flow-through system for applying cavitation in a hydrostatic chamber followed by hydrodynamic cavitation;

FIG. 2 illustrates another flow-through system for applying cavitation in a series hydrostatic-hydrodynamic arrangement; and

FIG. 3 illustrates steps of processing a liquid medium.

### DETAILED DESCRIPTION

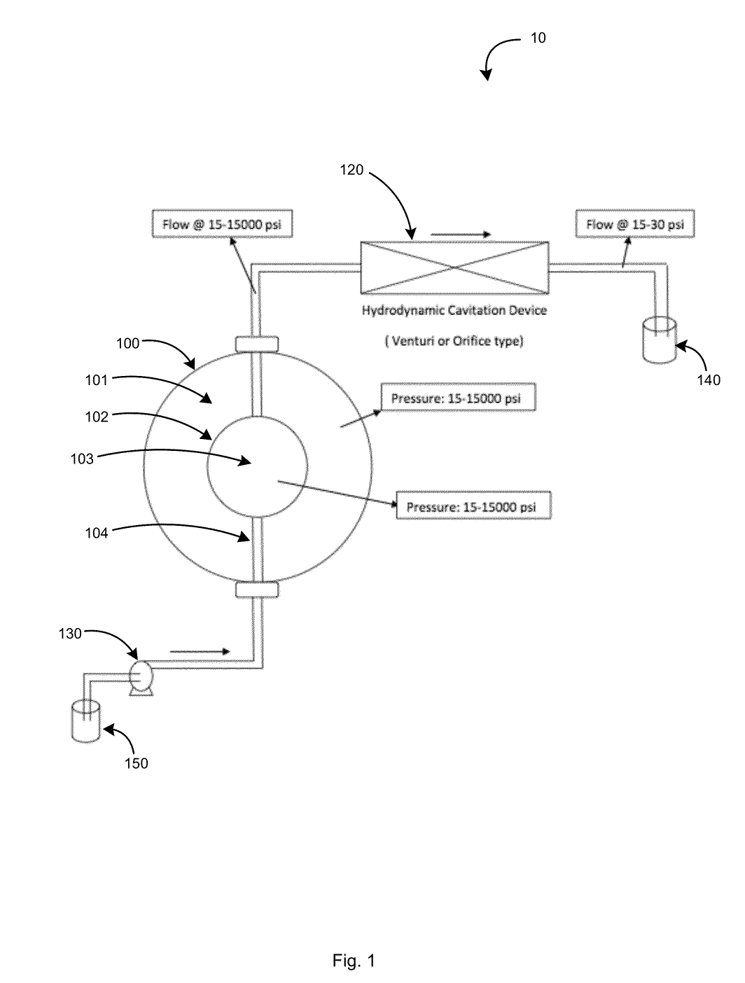

FIG. 1 illustrates an exemplary system 10 for achieving flow-through reactions in a reactor or reaction chamber including a hydrostatic cavitation apparatus or device 100. The hydrostatic cavitation device 100 includes an inner cavitation chamber 102 disposed within the volume of the overall cavitation device 100. In some embodiments, such as those described in co-pending applications by the present inventors and assignee (see, e.g., U.S. patent application Ser. No. 13/075,355, which is hereby incorporated by reference) the cavitation device 100 and inner cavitation reaction chamber 102 are substantially formed of concentric spherical shells. Fluid resides in the annular volume 101 separating the outer and inner shells 100, 102. Fluid also resides in inner cavitation volume 103. The acoustic drivers are sometimes applied to the outside surface of outer cavitation shell 100 as described in the above-referenced application.

Both the outer volume 101 and the inner volume 103 may be kept at a substantial hydrostatic pressure by way of a positive pressure apparatus, for example a pump 130. The increased hydrostatic pressure can allow more violent, and sometimes more productive and useful, cavitation to take place in the inner cavitation volume 103, as has been described in the above applications by the present inventor and assignee, which are hereby incorporated by reference.

Following the hydrostatic cavitation of the flowing fluid in hydrostatic cavitation device 100, a second stage of cavitation is applied to the same fluid. The second stage of cavitation may be in a hydrostatic or in a hydrodynamic cavitation element. In the drawing, a second stage hydrodynamic cavitation process is carried out in hydrodynamic cavitation device 120.

The fluid passing through the cavitation devices 100 and 120 can undergo chemical and physical changes due to the cavitation therein. As stated earlier, if water is the fluid passing through the system 10, then it can be cleaned or disinfected or otherwise purified by action of the cavitation. In a specific application, the micro organisms, germs, bacteria, fungus, algae, or other live pests can be neutralized, killed, or removed from the water stream.

The present disclosure is not meant to limit that which the inventors comprehend hereby. However, for the sake of illustration, some exemplary ranges for pressures applied to the water being treated are provided. In a specific embodiment, water is pumped from a source 150 (a holding tank for example) by pump 130, which raises the discharge static pressure of the water to a high pressure, e.g., 15 to 150,000 psi within the first (hydrostatic) cavitation device 100.

The hydrostatic cavitation device 100 discharges the water after it undergoes cavitation for a given length of time (by controlling the flow rate). The water at the above static pressure then flows in to said second cavitation stage 120. A venture or orifice nozzle causes hydrodynamic cavitation in the second stage 120 and pressure of the water drops to 15 to 30 psi upon discharge from the second cavitation chamber to a discharge holding tank 140, or to another part of the fluid processing system 10.

It can be seen here that the positive pressure developed in pumping the water into the first hydrostatic cavitation device 100 is not wasted, but is rather recovered by the second hydrodynamic cavitation device 120. This maximizes the amount of cavitation performed on the fluid passing through cavitation stages 100 and 120 while minimizing the loss of energy in raising the fluid pressure for best cavitation results.

Specifically, the inventor recognizes that pressurizing the fluid undergoing cavitation, then releasing this pressure to the environment following cavitation results in wasted effort and energy to pump the fluid to its higher pressure only to lose this energy when releasing the pressure. Also, the inventor recognizes that additional work on the fluid can be done, such as by passing it through a second hydrodynamic cavitation process, to further gain the benefits of cavitating the fluid.

Those skilled in the art would understand that an essentially arbitrary number of serially-arranged cavitation stages may be used. For example: one hydrostatic cavitation stage like the device 100 can be followed by a plurality of hydrodynamic cavitation stages like the device 120 all arranged in a cascade trailing behind one another until the fluid reaches about atmospheric pressure. In another arrangement, alternative positive and negative pressure stages (hydrostatic and hydrodynamic) can be set up and fluid flowed through these in series. In yet other embodiments, the present multi-stage cavitation processing can be applied in both serial and parallel forms simultaneously, with the fluid taking two or more parallel pathways, each of which includes two or more serially-arranged cavitation processing steps.

Of course other ancillary chemical, physical and mechanical filtration and water treatment steps are envisioned as known to those skilled in the art and would be used in conjunction with the above system 10.

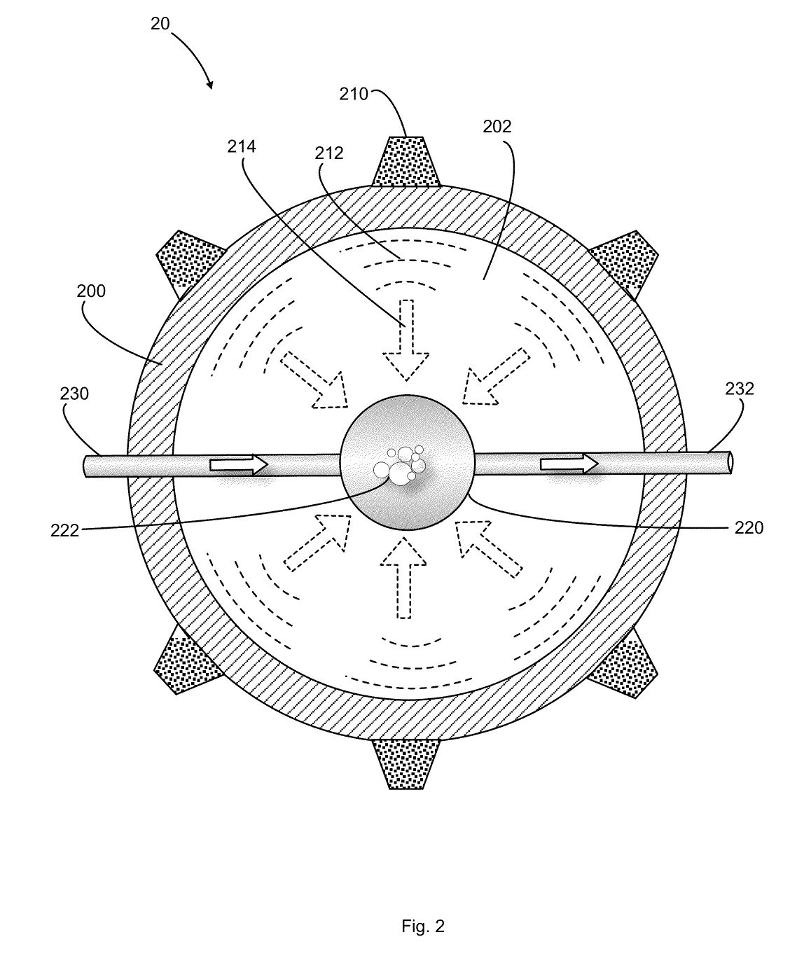

FIG. 2 illustrates an exemplary cross-section of an acoustic resonator with an acoustic reaction chamber therein. The acoustic resonator system 20 comprises a resonator shell 200 as described earlier, which may consist of a spherical or other three-dimensional volume having a solid material composition. In some embodiments, the resonator system 20 comprises a substantially spherical stainless steel resonator shell 200. The embodiment having such double walled reaction chamber within resonator construction is not strictly limiting of this invention, but only provided as an example thereof. Single resonator 100 construction may be employed as well.

A plurality of acoustic or ultrasonic energy sources 210 are disposed on and about an external surface or resonator shell 200. The acoustic transducers 210 may be driven individually or collectively or in groups so as to emit an acoustic energy field 212, which propagates inwardly as shown by arrows 214 towards a central volume of the resonator system 20.

A reactor or a reaction chamber 220 is located within the interior of resonator shell 200 and in some embodiments at or near a central volume of the resonator system 20. The reactor 20 provides a volume which may be filled with a material of interest and which may include a zone of cavitation 220 that acts on the material, fluid, or other substances injected in the reaction chamber 220. As described above, a material onto which it is desired that the acoustic field act may be injected into the reactor 220 through an inlet port 230 and following acoustic reaction at cavitation zone 222, the material may be passed out of the resonator system through outlet port 232.

In the example of a spherical or substantially spherical system 20, the resonator shell 200 and spherical reaction chamber 220 may be substantially concentric. That is, both the resonator shell 200 and the reaction chamber 220 within the resonator may be spherical in shape and may have the same or approximately the same centers. In this example, acoustic energy 212 will propagate from transducers 210 through shell 200 and inwardly 214 towards the surface of reactor 220. The reactor 220 is manufactured of a material, which is acoustically transparent or substantially permissive to ultrasound energy 212 to allow the ultrasound energy to travel through the walls of reactor 220, and in to the material contained within reactor 220. In some embodiments where cavitation is desired, the acoustic energy 212 propagates inwardly 214 through the walls of reactor 220 and inwardly towards cavitation zone 222 where a desired cavitation transformation or reaction takes place on the material contained within reactor 220.

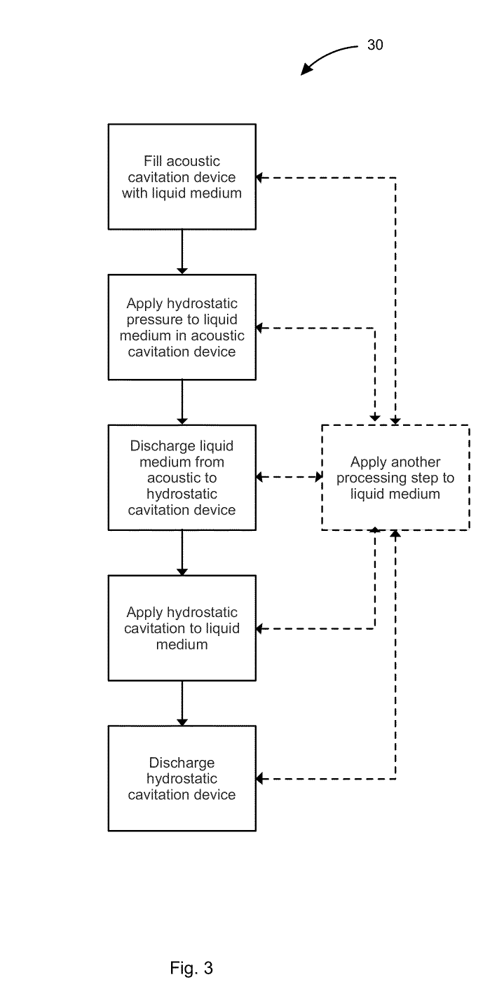

FIG. 3 illustrates exemplary steps of a method 30 for processing a liquid medium in a multi-stage system. The elements in dashed lines depict optional or flexibly chosen aspects of the method.

A liquid medium, which may include solid or particulate or biological additives or impurities is delivered into an acoustic cavitation chamber. The chamber may have only one set of outer shell walls or may include an interior reaction chamber into which acoustic energy can be delivered to cause cavitation induced changes therein. The liquid medium can be processed in bulk (fill and empty cycles) or as a flow-through continuous process.

The liquid medium and its contents are pressurized. For example the medium may be pumped into the acoustic cavitation chamber by a pump or fluid press to achieve a greater than ambient pressure hydrostatic pressure in the cavitation chamber.

The liquid medium and its contents undergo acoustic cavitation under hydrostatic pressure conditions, typically resulting in more violent bubble collapse events that enhance the results of the acoustic cavitation processing step.

After acoustic cavitation under static pressure, the contents of the acoustic cavitation step are released (either using a pump or on their own owing to their pressurized state so as to flow out of the acoustic cavitation vessel). The contents are delivered thus to a second cavitation stage such as a hydrodynamic cavitation device. In this second hydrodynamic cavitation device the fluid (generally liquefied or liquid or liquid matrix, slurry, solution, or mixture) is passed through the hydrodynamic cavitation device, releasing its remaining pressure and causing further cavitation therein.

In some aspects the second (hydrodynamic) cavitation device substantially recovers the pressure or energy put into pressurizing the liquid medium in the first acoustic cavitation step.

These and other features and alternative would now be apparent to those skilled in the art and are comprehended hereby so that the scope of the present disclosure is not limited to the illustrative embodiments described and explicitly shown.

What is claimed is:

1. A system for treating a liquid using acoustic cavitation, comprising:
an acoustic cavitation device;
a pressure source in fluid communication with said acoustic cavitation chamber;
a hydrodynamic cavitation device in fluid communication with said acoustic cavitation device;
said pressure source coupled to said acoustic cavitation device so as to raise a pressure of said liquid in said acoustic cavitation device above an ambient pressure; and
said hydrodynamic cavitation device coupled to said acoustic cavitation device so as to receive a discharge of liquid from said acoustic cavitation device.

2. The system of claim 1, further comprising an isolation valve that controllably shuts off the movement of liquid between said pressure source and said acoustic cavitation device.

3. The system of claim 1, further comprising an isolation valve that controllably shuts off the movement of liquid between said acoustic cavitation device and said hydrodynamic cavitation device.

4. The system of claim 1, further comprising at least one other liquid processing stage for affecting a result in said at least one other liquid processing stage in addition to cavitation by the above acoustic and hydrodynamic cavitation devices.

5. The system of claim 1, said acoustic cavitation device comprising a reaction chamber having walls defining a volume thereof and disposed within outer walls of said acoustic cavitation device.

6. A multi-stage method for cavitating a liquid medium, comprising:
introducing a liquid medium into an acoustic cavitation device;
pressurizing said liquid medium within the acoustic cavitation device to a desired pressure greater than ambient atmospheric pressure;
applying acoustic cavitation to said liquid medium under pressure inside said acoustic cavitation device;
releasing said liquid medium, after cavitating it in the acoustic cavitation device, to a hydrodynamic cavitation device;
applying hydrodynamic cavitation to said liquid medium in the hydrodynamic cavitation device; and
releasing the liquid medium from said hydrodynamic cavitation device.

7. The method of claim 6, further comprising placing the liquid medium in an inner reaction chamber disposed within walls of an outer shell of said acoustic cavitation device.

8. The method of claim 6, further comprising processing the liquid medium using another process in addition to said acoustic and said hydrodynamic cavitation steps.

9. The method of claim 6, said pressurizing comprising pumping said liquid medium into said acoustic cavitation device using a fluid pump.

10. The method of claim 6, said pressurizing comprising raising a hydrostatic pressure of said liquid medium in the acoustic cavitation device to a value between 10 and 20,000 psi above ambient atmospheric pressure.

11. The method of claim 6, applied to a liquid comprising water containing biological impurities and continuing the steps of claim 6 until said biological impurities have been substantially neutralized.
